(19) United States
(12) Patent Application Publication
(10) Pub. No.: US 2003/0234502 A1
(43) Pub. Date: Dec. 25, 2003

(54) Locking mechanism for locking/unlocking the folding frame structure of a folding golf cart

(76) Inventor: Wen-Tsan Lin, Taichung (TW)

Correspondence Address: Keith Kline, PRO-TECHTOR INTERNATIONAL SERVICES, 20775 Norada Court, Saratoga, CA, 95070-3018, US

(21) Appl. No.: 10/175,630

(22) Filed: Jun. 19, 2002

(51) Int. Cl. B62B 1/00

(52) U.S. Cl. 280/47.26

(57) ABSTRACT

A locking mechanism is installed in the upper main frame and lower main frame of a folding golf cart and adapted for locking the upper main frame in an extended operative position in axial alignment with the lower main frame. The locking mechanism includes a receptacle fixedly provided in a front end of the lower main frame, and a spring-supported latch means provided at the upper main frame and adapted for engaging into the receptacle to lock the upper main frame when the upper main frame turned to the extended operative position.

### BACKGROUND OF THE INVENTION

1. Field of the Invention

The present invention relates to a folding frame structure for golf cart and, more particularly, to a locking mechanism for locking the folding frame structure of a folding golf cart.

2. Description of the Related Art

FIG. 1 shows a golf cart constructed according to the prior art. According to this design, the golf cart comprises a folding frame structure A. The folding frame structure A comprises a lower main frame A1 holding two wheels B bilaterally at the bottom side and two bag cradles C at the front and rear end thereof, and an upper main frame A2 pivoted to the lower main frame A1. The lower main frame A1 has a locating rod A11 extended from the front end thereof. The upper main frame A2 has a front end terminating in a handgrip D. A sliding socket E is coupled to the upper main frame A2 and adapted for receiving the locating rod A11. When the upper main frame A2 extended out, the sliding socket E is moved backwards along the upper main frame A2 into engagement with the locating rod A11 to hold the upper main frame A2 in the operative position. This folding frame structure A is not satisfactory in function. When the golf cart moved over an uneven ground area, the sliding socket E may be forced away from the locating rod A11, thereby causing the folding frame structure A to collapse.

### SUMMARY OF THE INVENTION

The present invention has been accomplished to provide a locking mechanism for locking the folding frame structure of a folding golf cart, which eliminates the aforesaid problem. It is the main object of the present invention to provide a locking mechanism for golf cart, which is easy to operate. It is another object of the present invention to provide a locking mechanism for golf cart, which is practical in use for locking the folding frame structure of the golf cart positively in the extended operative position. According to the present invention, the locking mechanism is installed in the upper main frame and lower main frame of a folding golf cart and adapted for locking the upper main frame in an extended operative position in axial alignment with the lower main frame. The locking mechanism comprises a receptacle fixedly provided in a front end of the lower main frame, and a spring-supported latch means provided at the upper main frame and adapted for engaging into the receptacle to lock the upper main frame when the upper main frame turned to the extended operative position.

### BRIEF DESCRIPTION OF THE DRAWINGS

FIG. 1 illustrates a folding golf cart constructed according to the prior art.

FIG. 2 illustrates a folding golf cart constructed according to the present invention.

FIG. 2A is an enlarged view of a part of FIG. 2 showing the locking mechanism unlocked.

FIG. 3 illustrates the locking mechanism unlocked, the folding frame structure collapsed according to the present invention.

FIG. 4 is an exploded view of the latch unit of the locking mechanism according to the present invention.

FIG. 5 is an assembly view of the latch unit shown in FIG. 4.

FIG. 6 is a sectional assembly view of the latch unit according to the present invention.

FIG. 7 is a sectional view of the latch unit showing the latch moved forwards relative to the casing according to the present invention.

FIG. 8 is a sectional view of the latch unit showing the latch moved backwards relative to the casing according to the present invention.

### DETAILED DESCRIPTION OF THE PREFERRED EMBODIMENT

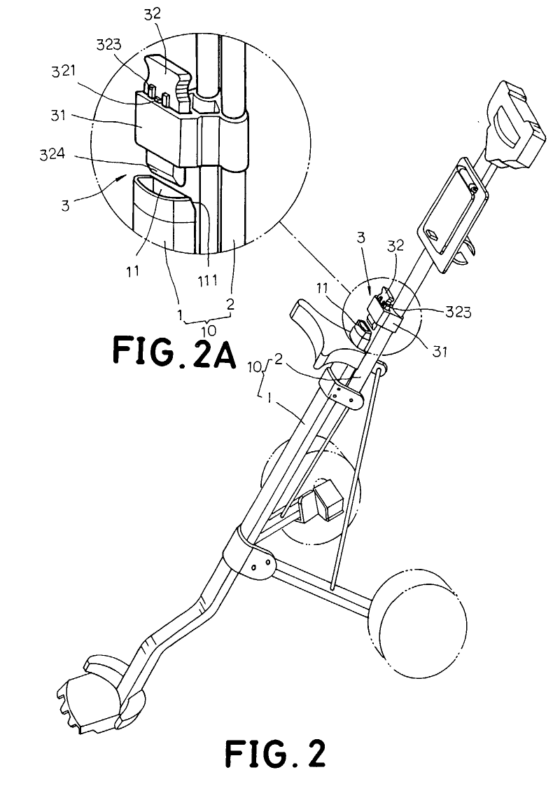

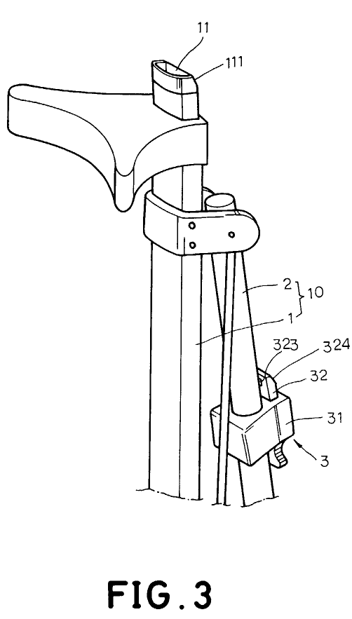

Referring to FIGS. 2, 2A and 3, a golf cart folding frame structure 10 is shown comprised of a lower main frame 1 and an upper main frame 2 pivoted to the lower main frame 1. The upper main frame 2 can be turned relative to the lower main frame 1 between the extended operative position approximately in axial alignment with the lower main frame 1, and the received non-operative position. A locking mechanism is provided for locking the upper main frame 2 in the extended operative position. The locking mechanism comprises a receptacle 11 fixedly provided at one end, namely, the front end of the lower main frame 1, and a latch unit 3 provided at the upper main frame 2.

Referring to FIGS. from 4 through 6, the latch unit 3 comprises a casing 31, two compression springs 30, and a latch 32. The casing 31 comprises two parallel mounting holes 311 bilaterally disposed near the bottom side thereof and axially extended through the front and rear sidewalls thereof for coupling to the upper main frame 2, a latch slot 312 extended through the front and rear sidewalls and spaced above the mounting holes 311, a first spring groove 313 disposed in the top side of the latch slot 312 and extended to the rear sidewall of the casing 31, a second spring groove 314 disposed in the bottom side of the latch slot 312 corresponding to the first spring groove 313 and extended to the front sidewall of the casing 31. The first spring groove 313 and the second spring groove 314 are extended in reversed directions, each having an inner close end and an outer open end. The latch 32 is inserted into the latch slot 312 of the casing 31, comprising a spring groove 320 longitudinally disposed in the top sidewall thereof corresponding to the first spring groove 313 of the casing 31, a top stop 321 disposed in one end of the spring groove 320 corresponding to the open end of the first spring groove 313 of the casing 31, and a bottom stop 322 protruded from the bottom sidewall thereof corresponding to the open end of the second spring groove 314 of the casing 31. One of the compression springs 30 is received in the first spring groove 313 of the casing and the spring groove 320 of the latch 32 and stopped between the inner close end of the first spring groove 313 and the top stop 321 of the latch 32. The other of the compression springs 30 is received in the second spring groove 314 of the casing 31 at the bottom side of the latch 32 and stopped between the inner close end of the second spring groove 314 of the casing 31 and the bottom stop 322 of the latch 32.

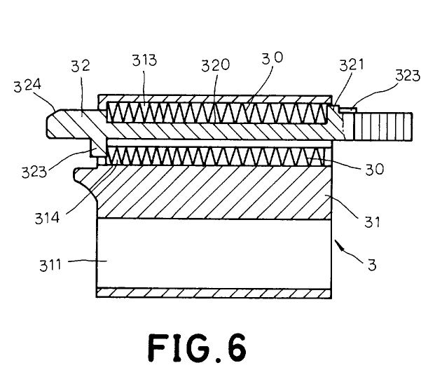

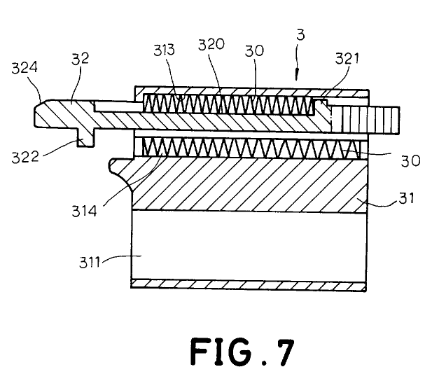

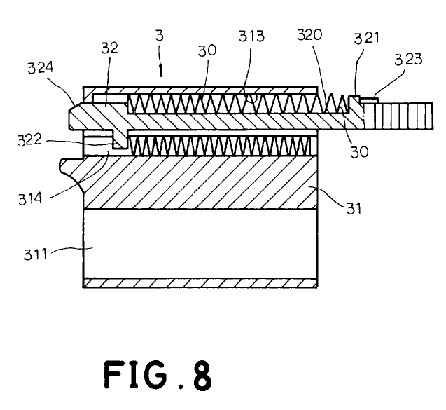

Referring to FIGS. from 6 through 8 again, because the top stop 321 and bottom stop 322 of the latch 32 are respectively stopped at the compression springs 30 in the spring grooves 313;314 inside the casing 31, the latch 32 is prohibited from falling out of the casing 31 (see FIG. 6), and can be moved axially forwards (see FIG. 7) or backwards (see FIG. 8) relative to the casing 31. When released the latch 32, the compression springs 30 automatically return the latch 32 from the position shown in FIG. 7 or the position shown in FIG. 8 to the position shown in FIG. 6.

When extending out the folding frame structure 10 of the lower main frame 1 and the upper main frame 2, pull the latch 32 backwards from the position shown in FIG. 6 to the position shown in FIG. 8, for enabling the upper main frame 2 to be turned to the extended operative position in axial alignment with the lower main frame 1 as shown in FIGS. 2 and 2A, and then release the latch 32 from the hand, enabling the compression springs 30 to return the latch 32 to the position shown in FIG. 6 where the front end 324 of the latch 32 is engaged into the receptacle 11 to lock the upper main frame 2 in the extended operative position. On the contrary, when pulling the latch 32 backwardly away from the receptacle 11, the upper main frame 2 is unlocked and can be turned relative to the lower main frame 1 to the received non-operative position.

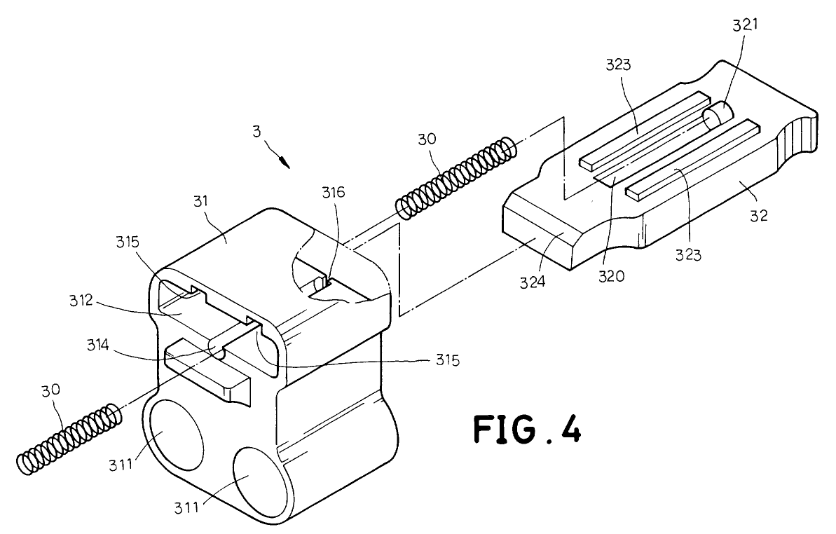

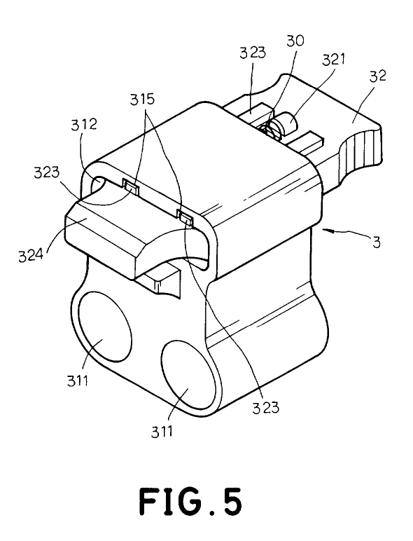

Referring to FIGS. 4 and 5 again, the casing 31 further comprises a plurality of sliding tracks 315 disposed in parallel to the spring grooves 313;314, and the latch 32 comprises a plurality of longitudinal rails 323 respectively coupled to the sliding tracks 315 for guiding movement of the latch 32 relative to the casing 31.

Further, the mounting holes 311 of the casing 31 are made subject to the structure of the upper main frame 2, i.e., the number and shape of the mounting holes 311 are determined subject to the number and cross section of the frame rods of the upper main frame 2.

Referring to FIGS. 2, 4, and 6 again, the front end 324 of the latch 32 is beveled for easy insertion into the receptacle 11. The receptacle 11 has a beveled front guide edge 111 adapted for guiding the latch 32 into the locking position.

Referring to FIGS. 4 and 6 again, the close inner end of the second spring groove 314 of the casing 31 has an opening 316 for allowing the bottom stop 322 of the latch 32 to pass when inserting the latch 32 into the latch slot 312 of the casing 31 during the assembly of the latch unit 3.

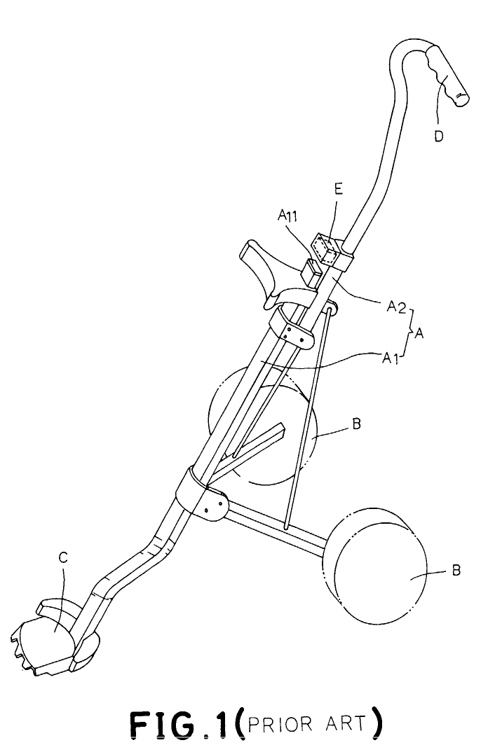

A prototype of locking mechanism for locking the folding frame structure of a golf cart has been constructed with the features of FIGS. 1˜8. The locking mechanism functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A locking mechanism installed in the upper main frame and lower main frame of a folding golf cart and adapted for locking said upper main frame in an extended operative position in axial alignment with said lower main frame, the locking mechanism comprising a receptacle fixedly provided in a front end of said lower main frame, and a spring-supported latch means provided at said upper main frame and adapted for engaging into said receptacle to lock said upper main frame when said upper main turned to the extended operative position.

2. The locking mechanism as claimed in claim 1, wherein said spring-supported latch means comprises a casing fixedly mounted on said upper main frame, said casing comprising a front sidewall, a rear sidewall, a latch slot extended through said front sidewall and said rear sidewall, a first spring groove disposed in a top side of said latch slot and extended to said rear sidewall, and a second spring groove disposed in a bottom side of said latch slot and extended to said front sidewall, a latch inserted into said latch slot and moved relative to said casing between a first position where said latch is engaged into said receptacle to lock said upper main frame in the extended operative position and a second position where said latch is disengaged from said receptacle for enabling said upper main frame to be turned relative to said lower main frame, said latch comprising a top stop protruded from a top side thereof and a bottom stop protruded from a bottom side thereof, a first compression spring received in said first spring groove inside said latch slot of said casing and stopped between an inner close end of said first spring groove and the top stop of said latch, and a second compression spring received in said second spring groove inside said latch slot of said casing and stopped between an inner close end of said second spring groove and the bottom stop of said latch.

3. The locking mechanism as claimed in claim 2, wherein said casing comprises a plurality of sliding tracks disposed in said latch slot; said latch comprises a plurality of rails respectively coupled to said sliding tracks for guiding movement of said latch relative to said casing.

4. The locking mechanism as claimed in claim 2, wherein said casing comprises at least one mounting hole adapted for coupling to said upper main frame.

5. The locking mechanism as claimed in claim 2, wherein said latch has a beveled front end adapted for engaging into said receptacle.

6. The locking mechanism as claimed in claim 2, wherein said receptacle has a beveled front guide edge adapted for guiding said latch into said receptacle.

7. The locking mechanism as claimed in claim 2, wherein said second spring groove has an opening in a close inner end thereof for the passing of the bottom stop of said latch.

8. The locking mechanism as claimed in claim 2, wherein said latch has a longitudinal spring groove disposed in the top side thereof and extended from said top stop for receiving a part of said first compression spring.
